(19) United States
(12) Patent Application Publication
(10) Pub. No.: US 2009/0106797 A1
(43) Pub. Date: Apr. 23, 2009

(54) APPARATUS, AND ASSOCIATED METHOD, FOR PROVIDING PERSONALIZED CHANNEL CONTENT

(75) Inventor: David B. Lucente, Spring Hill, TN (US)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 11/876,493

(22) Filed: Oct. 22, 2007

(51) Int. Cl. H04N 5/445

(52) U.S. Cl. 725/46

(57) ABSTRACT

A device for identifying preferred television programming, or other multi-media, content and providing the identified content on a personalized channel. An identifier identifies the preferred content through monitoring of the viewing habits of a viewer. Manual input of information is also permitted to identify, or edit, the preferred content and its viewing schedule. Once the preferred content is identified, the content is provided on a personalized channel. And when the viewer selects to view the personalized channel, the preferred content, preferred by the user is viewed by viewing the single, personalized channel.

The present invention relates generally to a manner by which to facilitate viewing of television or other multi-media content. More particularly, the present invention relates to apparatus, and an associated method, by which to create a personalized channel upon which television, or other multi-media, content is provided, available for viewing by a viewer.

A viewer's viewing behavior is monitored, and the content that is provided on the personalized channel is selected in response to the viewer's viewing behavior.

### BACKGROUND OF THE INVENTION

Television viewers in many areas are provided with multiple channels of broadcast content available for viewing. Viewers in urban areas are sometimes able to receive a dozen, or more, over-the-air broadcast channels. And, cable, or satellite, subscriptions sometimes provide in excess of one hundred channels available for viewing at any time. With increases in broadcasting capacities, both over-the-air and by subscription, the number of channels available for viewer selection to view content shall likely increase. And, with the increasing capability of other radio, and wired, communication systems to broadcast and multicast programming content, viewers shall increasingly be able to receive multimedia content by way of these additional types of communication systems.

In spite of the large selection of channels, many viewers actually only view a limited amount of the content. For example, a typical viewer develops, or has, a preference for a number of television shows and regularly watches the preferred shows. These shows are, e.g., television series or are regularly broadcast at the same time, on the same channel, each week, or otherwise on a periodic basis. A viewer must remember the television schedule, or resort to a television guide listing, in order to select the appropriate channel to view at the proper time, the preferred show.

Sometimes, however, while the viewer might be able to remember the preferred show or time, the channel upon the show is broadcast is sometimes forgotten. The problem is compounded by the regular occurrence of the broadcast channel numbers being different than the channel numbers used by a cable broadcast or satellite broadcast operator.

Various devices are sometimes positioned between a television signal input port of a television set and a local source of the television channels, e.g., a coaxial cable or an antenna. The device comprises, for instance, a cable box that converts television signals transported along the cable into a form suitable for display at the screen of the television set. Or, for instance, the device forms a recording device, such as a digital recording device, that provides for recording of received content. In some of such digital recorders, as well as other devices, the automatic operation is provided in which programming content on a specific channel is recorded at a specific time. A TiVO™ recorder, e.g., records content, permitting its subsequent viewing. Various devices also provide for interactive operation, such as an Ensequence™ interactive program that permits a viewer to play along with a game show. Other devices provide for data collection to provide for popularity statistics of broadcast content. Apple™ T.V. provides for wireless connections with a computer to permit viewing of stored content. A total T.V. monitor™ also provides for data collection of viewing habits. And, a GIST™ service comprises a mobile utility service intended to enable use of mobile phones to receive personalized content recommendations.

While these devices and features, as well as others, provide various advantageous functionality, such devices and features fail to facilitate viewing of favorite programming without channel selection by a viewer.

If an improved manner could be provided by which to facilitate better viewing by a user of preferred content, a viewer's viewing experience would be improved.

It is in light of this background information related to the viewing of multi-media content that the significant improvements of the present invention have evolved.

### SUMMARY OF THE INVENTION

The present invention, accordingly, advantageously provides apparatus, and an associated method, by which to facilitate a viewing of television, or other multi-media, content.

Through operation of an embodiment of the present invention, a manner is provided by which to create a personalized channel upon which television, or other multi-media, content is provided, thereby to be made available for viewing by a viewer.

The personalized channel forms a single viewing channel that provides the viewer's preferred content based upon historical viewing patterns of the viewer.

In one aspect of the present invention, the viewing patterns, i.e., habits, of a viewer are monitored in order to obtain information pertaining to content preferred by the viewer, based upon content actually viewed by the viewer. Information tracked by the monitoring of the viewer's viewing habits identifies the content, the channel upon which the content is broadcast, the time upon which the content is broadcast and the day of the week, or other time period, that the content is viewed.

In another aspect of the present invention, the information collected during monitoring of the viewer's viewing habits during a monitoring period are maintained and stored in a listing, such as a listing maintained at a memory element. The listing is formatted in any desired manner, indexing together the indicia, i.e., the viewed content, and the channel upon which the reviewed content is received. The listing, most simply, identifies the content most-recently viewed during times and dates within the monitoring period. That is to say, newer information is overwritten upon older information so that for any particular time period, and day, the listing includes a single entry. Or, a weighting algorithm is utilized that weights, e.g., more recently-viewed content relative to content less-recently viewed during the same time and day. Or, additional criteria is used, such as viewing lengths of different content at the relevant times and days and using such information for weighting purposes.

In another aspect of the present invention, the content identified in the listing is provided on a single output channel, available to be provided to a display device at which the content is viewable. The content, provided on any of a plurality of input channels, is output on the single output channel. Thereby, a viewer is able to view preferred content, based upon the viewer's prior viewing behavior and habits. The viewer need not recall the channel upon which preferred content is broadcast. Instead, the viewer need only be aware of the personalized channel upon which the personalized content is provided.

In another aspect of the present invention, manual input of information associated with preferred content is also provided. A viewer is able to input information that identifies preferred content that is to be contained in the listing and used to select content that is to be provided on the personalized channel. The manually-input information is input, e.g., by way of an input keyboard, use of screen cursor and user interface that analogously provides for user input of information. Manual input of information includes, e.g., manual input of the preferred content, its time and day of broadcast, and the broadcast channel upon which the preferred content is broadcast. Editing of stored information is also provided by way of manual input. For instance, if the broadcast channel upon which the preferred content changes, a viewer is able to update the listing entries to indicate the channel change. Or, if the time or day at which the preferred content is broadcast changes, the viewer is able to update the listing.

In another aspect of the present invention, a default channel is used in the event that no preferred content is identified for a particular time, day, or other period. The default channel is selected in any of various manners, for instance, most simply, a viewer selects a broadcast channel to be a default channel, and content broadcast thereon is provided on the personalized channel in the event that no other content is preferred. For instance, if no preferred content is ascertained as a result of monitoring of the viewer's viewing habits or otherwise provided, content broadcast on the default channel is provided on the personalized channel during such periods. A default channel is also selectable as a result of analysis of the monitored viewing behavior. That is to say, if the viewing behavior indicates a preponderance of viewing of a particular channel, than the identified channel is selected as the default channel. Other selection criteria are possible. A default channel is also available on a time basis, such as a time of day basis or a day of the week basis. And, as a result, more than one default channel is selected, depending upon the time or day at which the default channel content is needed on the personalized channel.

In another aspect of the present invention, the functionality that identifies the viewer's preferred viewing behavior and provides a personalized channel response thereto is formed of a discrete device. In another implementation, the functionality is embodied in another device, such as a digital receiver, a digital video recorder, or in a television receiver. In any of such implementations, the personalized channel provides content that is viewable by a viewer on a single channel. The viewer need not remember individual channels on which preferred content is broadcast at any particular time.

In these and other aspects, apparatus and an associated method, is provided for facilitating display to a viewer of selected multi-media content. The content is sourced at a plurality of multi-media content sources. A viewer behavior identifier is configured to identify a viewer multi-media viewing pattern. A content provider is configured to provide the selected multi-media content in conformity with the viewer multi-media viewing pattern identified by the viewer behavior identifier.

A more complete appreciation of the scope of the present invention and the manner in which it achieves the above-noted and other improvements can be obtained by reference to the following detailed description of presently-preferred embodiments taken in connection with the accompanying drawings, which are briefly summarized below, and by reference to the appended claims.

### BRIEF DESCRIPTION OF THE DRAWINGS

FIG. 1 illustrates a functional block diagram of a device of an embodiment of the present invention.

FIG. 2 illustrates a content display flow diagram representative of logical operation of an embodiment of the present invention.

FIG. 3 illustrates a method flow diagram representative of an embodiment of the present invention.

### DETAILED DESCRIPTION

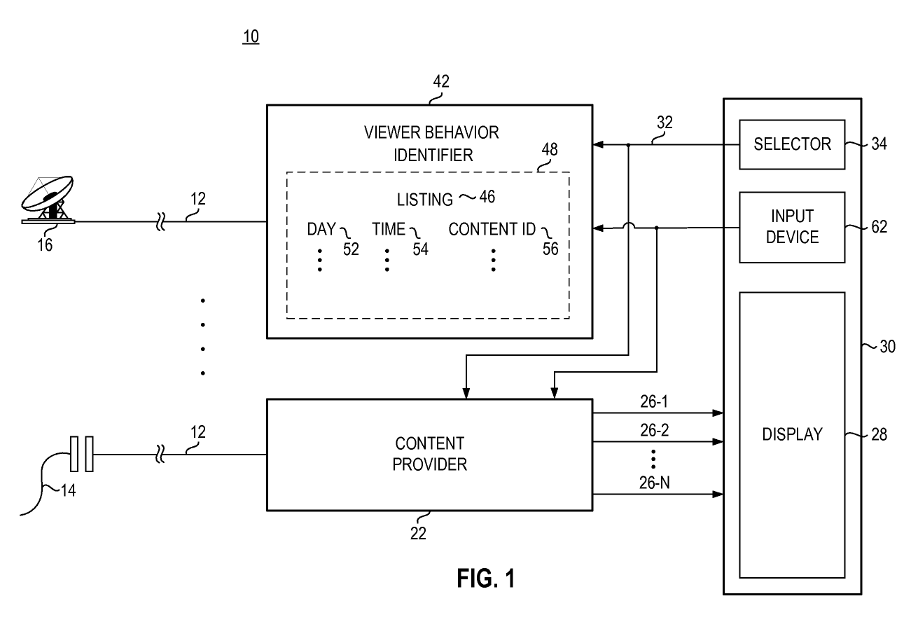

Referring first to FIG. 1, an apparatus, shown generally at 10, that forms the device of an embodiment of the present invention is provided with multi-media content, such as television programming content broadcast on a plurality of input channels 12. The content is, for example, provided on a coaxial cable 14 by a cable television operator or detected by an antenna 16, here a parabolic antenna such as that used to receive television programming broadcast by a satellite television operator. The antenna is also representative of an antenna used in the reception of conventional over-the-air television programming or other content. Different content, typically, is provided on the different channels. For instance, cable television systems and satellite television systems sometimes have one hundred or more channels, each of which broadcasts different content.

The content broadcast on each of the input channels is provided to a content provider 22. The content provider operates to provide content on output channels 26 that are provided to a screen display 28, such as a television screen, CRT, or the like, of a viewer interface 30. As shall be described below, the content provider provides personalized content on the channel 26-1, and the channel is referred to herein as a personalized channel. The channels 26-K through 26-N are provided with content corresponding to the content provided on the input channels 12, such as in a one-to-one relationship.

In the exemplary implementation, a viewer of the display screen 28 selects content provided on any of the channels 26 for viewing. And, an indication of the channel selection is provided to the content provider by way of the line 32. The line 32 extends from a channel selector 34 that provides for viewer selection of the channel whose content is to be provided to, and displayed at, the display 28. In one implementation, absent a selection by the viewer of a channel, content provided on the personalized channel 26-1 is displayed at the display.

Pursuant to an embodiment of the present invention, the content provided by the content provider on the personalized channel 26-1 is selected responsive to viewer behavior monitored by a viewer behavior identifier 42. The viewer behavior identifier, as well as other elements of the device 10, is constructed in any desired manner, including algorithms executable by processing circuitry. The identifier monitors viewer behavior and identifies preferred content. That is to say, content selected for viewing by the viewer is considered to be content that is preferred by the viewer. As television programming content, as well as other content, is oftentimes broadcast according to a repetitive schedule, e.g., every Monday evening at 8:00 p.m., etc. Identified viewer behavior is provided to the content provider and used by the content provider to select content that is to be provided on the personalized channel 26-1.

The personalized content provided on the personalized channel corresponds to the programming, or other, content that is identified by the identifier as the content preferred to be viewed by the viewer. And, selection by the viewer of the personalized channel 26-1 by way of the selector 34, once the viewer's behavior has been identified, provides the identified, preferred content on the personalized channel to be displayed on the display 28. As the preferred content is provided on a single channel, i.e., the personalized channel, the viewer need not select, i.e., switch to, another channel to obtain the preferred content. The viewer need not even remember the channels upon which the preferred content is broadcast once the identifier 42 has operated. Improved viewer experience is provided as the viewer is able to view preferred content without needing to remember the channel upon which the preferred content is broadcast.

In the exemplary implementation, the identified preferred content is stored at a listing 46 maintained at a memory element 48. The listing identifies preferred content 56 indexed together with, a day-of-week 52 and time-of-day 54. During a monitoring period, either of fixed duration or indeterminate duration, e.g., a non-ending period, the identifier monitors the viewer's viewing habits. When television programming, or other, content is viewed by a viewer, the channel upon which the content is broadcast is identified, together with the time and day at which the content is viewed. And, the listing is populated with the identified information. If the identifier detects that the viewer's viewing habits change, viz., that the preferred programming content changes, than the listing is correspondingly updated. Prior listing entries are, e.g., overwritten with updated listing entries. In one implementation, weightings are associated with identifications made at different times. If an identification is made more distant in time, the identification is weighted less than content identified more recently in time. And, overwriting of stored entries is made when weightings of new identifications outweigh cumulative, weighted, prior entries. Other weighting, and other listing updating schemes, are, of course, also possible.

In the exemplary implementation, a default channel is further identified. At time periods in which no identification is made of preferred content, the default channel is identified for provision on the personalized channel. The default channel is, in one implementation, selectable by the viewer, such as by selection by way of an input device 62, identification of which is provided to the identifier 42 and to the content provider 22.

A dynamic scheme is thereby provided by which to identify and update preferred content to be viewed by a viewer at any viewing time.

In the exemplary implementation, additional manual input by a viewer to provided manual entry of information related to preferred content, its broadcast channel, and dates and times associated with the preferred content. Manual input is by way of, e.g., a keyboard comprising the input device or a cursor-screen display type of input device. Manual entry of information is used, additionally, for instance, when the date, time, or channel of broadcast of preferred content changes, and the viewer is aware of such change.

In the exemplary implementation, additionally, the viewer selects a time threshold to be used by the identifier 42 in its identification of preferred content. That is to say, to be considered as preferred content, the content must be viewed by a viewer for at least a threshold period. For instance, if programming content is of a duration of thirty minutes, a time threshold is set, and at least that threshold portion of the thirty minute programming content must be viewed in order for the identifier to identify the content as preferred content. In an alternate implementation, an identification of preferred content is made. That is to say, first content is identified as the preferred content during a first period, and second content is identified as preferred content during a second period, all in proportion to the threshold or percentage of viewing portions viewed previously by the viewer. And, in one implementation, a minimum threshold of a minimum period of programming content must be viewed in order for any data to be saved by the identifier.

In a further implementation, multiple, preferred personalized channels are provided for different viewers. That is to say, with respect to FIG. 1, multiple personalized channels 26-1 are provided, each associated with a different viewer. Procedures carried out by the identifier and the content provider 42 and 22, respectively, are as above-described, but for each of the viewers.

Additionally, in the exemplary implementation, a scheduler screen is displayable on the display 28. The scheduler screen operates in conjunction with the manual input device 62 to provide for manual input of information associated with preferred content, including its identity, time, date, or day-of-week of performance.

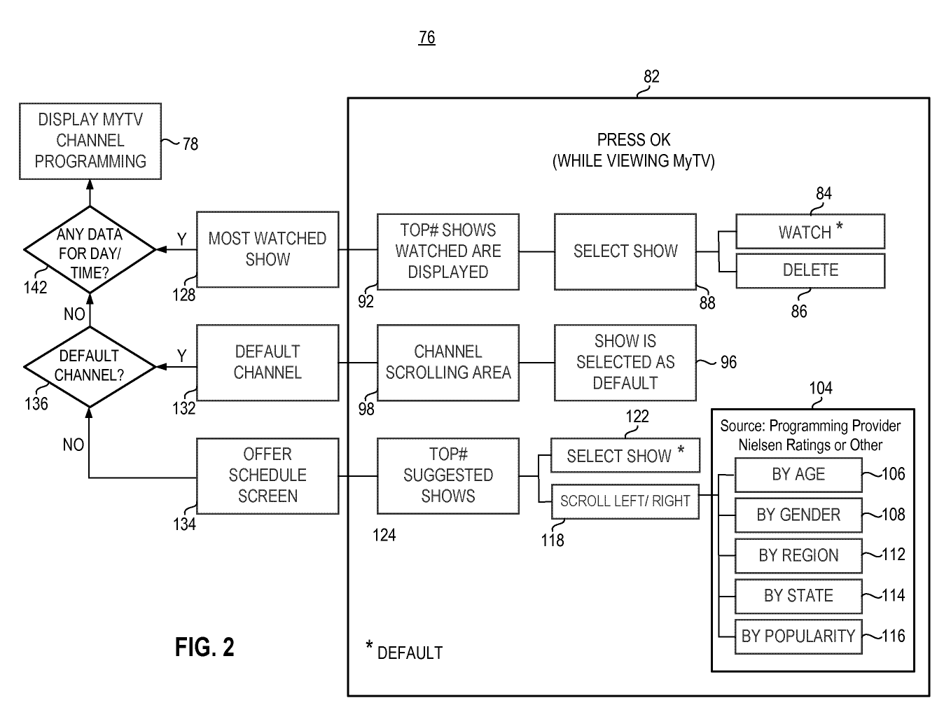

FIG. 2 illustrates a process diagram, shown generally at 76, representative of exemplary operation of the device shown in FIG. 1. As noted previously, the device is implementable, alternately, as a discrete device, or as part of another entity, such as a digital reporter, digital video recorder, or television set or screen.

First, and as indicated by the block 78, a channel programming display is displayed on a video display device, such as a television monitor or screen. A viewer that views the display on the monitor or screen is prompted to, or is otherwise able to, input information associated with preferred content. The block 82, identified as “press OK”, provides manners by which to identify preferred content and identify a default channel from which the personalized channel maintains default content in the event that no other preferred content is identified. A top row of the block 82 identifies operations by which to identify preferred content. The block 84 represents watching, i.e., viewing of programming content. A delete block is representative of deletion of consideration of the viewed content. Otherwise, as indicated by the block 88, the viewed content is selected. And, as indicated by the block 92, the top number of shows, i.e., viewed content, is displayed.

As indicated by the second row, a show is selected, indicated by the block 96, as a default and its associated channel is selected as a default channel. The block 98 is represented as a scrolling area permitting a viewer to scroll through channels.

The bottom row (as-shown) of the block 82, provides for the selection of content, here television programming content, based upon a ratings service. Various rating criteria are indicated, an age criteria 106, a gender criteria 108, a region criteria 112, a state criteria 114, and a popularity criteria 116. The directional scrolling, i.e., left-to-right as well as up-to-down, is provided, indicated by the block 118. And, a content selection capability is indicated by the block 122. The block 124 represents a top number of suggested shows.

Through appropriate selection by the viewer within the block 82, a most watched show 128, a default channel 132, and an offer schedule screen capability 134 are all provided.

Decision blocks 136 and 142 identify whether a default channel is selected and whether preferred content is identified for a particular time. Responsive to such decisions at the decision blocks, appropriate channel programming is displayed, indicated by the block 78.

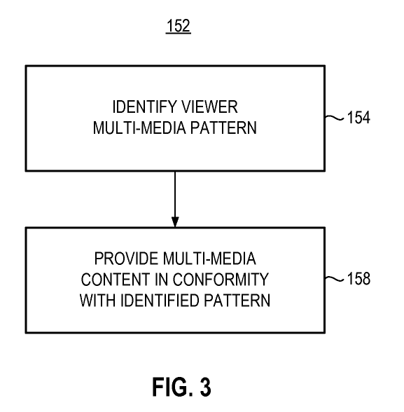

FIG. 3 illustrates a method flow diagram, shown generally at 152, representative of the method of operation of an embodiment of the present invention. The method facilitates display to a viewer of selected multi-media content. The multi-media content is sourced at a plurality of multi-media content sources.

First, and as indicated by the block 154, a viewer multi-media pattern is identified. Then, and as indicated by the block 158, the selected multi-media content is provided in conformity with the viewer multi-media viewing pattern.

Thereby, a mechanism is provided by which to provide a personalized channel permitting a viewer to view preferred content that is provided thereon. The preferred content provided to the personalized channel is identified, either by manual input, or by monitoring of viewer habits to identify the preferred content.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. Apparatus for facilitating display to a viewer of selected multimedia content sourced at a plurality of multimedia content sources, said apparatus comprising:
a viewer behavior identifier configured to identify a viewer multimedia viewing pattern; and
a content provider configured to provide the selected multimedia content in conformity with the viewer multimedia viewing pattern identified by said viewer behavior identifier.

2. The apparatus of claim 1 wherein the multimedia content comprises television content and wherein said viewer behavior identifier is configured to identify a viewer television viewing pattern.

3. The apparatus of claim 2 wherein the viewer television viewing pattern is defined as a function of time indicia.

4. The apparatus of claim 2 wherein the viewer television viewing pattern is defined as a function of a day-of-week indicia.

5. The apparatus of claim 1 wherein said viewer behavior identifier is further configured to maintain a listing of the viewer multimedia viewing pattern.

6. The apparatus of claim 5 wherein said viewer behavior identifier is further configured to maintain the listing by monitoring the viewer multimedia viewing pattern.

7. The apparatus of claim 1 wherein said viewer behavior identifier is further configured to receive manually-entered information that identifies at least part of the viewer multimedia viewing pattern.

8. The apparatus of claim 1 wherein said viewer behavior identifier is further configured to update identification of the viewer multimedia viewing pattern.

9. The apparatus of claim 1 wherein said content provider is configured to provide the selected multimedia upon a selected output channel.

10. The apparatus of claim 9 wherein the plurality of multimedia content sources are sourced on a plurality of input channels and wherein the selected output channel provides the selected multimedia sourced upon a selected input channel upon the selected output channel during a selected period according to the viewer multimedia viewing pattern.

11. The apparatus of claim 10 wherein said content provider is further configured to provide default multimedia sourced at a selected one of the input channels upon the selected output channel absent, during a selected period, identification of the viewer multimedia viewing pattern.

12. The apparatus of claim 1 wherein identification of the viewer multimedia viewing pattern during a selected period includes identification of viewed multimedia if viewed for at least a selected period.

13. The apparatus of claim 1 further comprising a display configured to display the content provided by said content provider.

14. The apparatus of claim 1 further comprising a display configured to provide user display of the viewer multimedia viewing pattern identified by said viewer behavior identifier.

15. A method for facilitating display to a viewer of selected multimedia content sourced at a plurality of multimedia content sources, said method comprising:
identifying a viewer multimedia viewing pattern; and
providing the selected multimedia content in conformity with the viewer multimedia viewing pattern.

16. The method of claim 15 wherein said providing comprises providing the selected multimedia content on a single output channel.

17. The method of claim 15 wherein said identifying the viewer multimedia viewing pattern comprises monitoring viewer viewing patterns of multimedia content and identifying multimedia content as viewed if viewed for at least a threshold period.

18. The method of claim 15 wherein said identifying further comprises manually identifying at least part of the viewer multimedia viewing pattern.

19. The method of claim 15 further comprising displaying the selected multimedia content.

20. A television content device for creating personalized television content, said television content device comprising:
a viewer viewing behavior tracker configured to track viewer viewing behavior during a tracking period; and
a personalized television channel content provider configured to provide television content, subsequent to the tracking period, on a single television channel responsive to the viewer viewing behavior.
